(19) United States
(12) Patent Application Publication
(10) Pub. No.: US 2011/0032886 A1
(43) Pub. Date: Feb. 10, 2011

(54) METHOD FOR ASSIGNING WIRELESS NETWORK TRANSMISSION RESOURCE AND APPLICATION THEREOF

(75) Inventors: Hsin-Pu CHUNG, Taipei City (TW); Yi-Chih TUNG, Taipei City (TW); Yen-Ru PENG, Taipei County (TW); Li-Hung LIAO, Yunlin County (TW)

Correspondence Address: BRIAN M. MCINNIS, 12th Floor, Ruttonjee House, 11 Duddell Street, Hong Kong, HK

(73) Assignee: INSTITUTE FOR INFORMATION INDUSTRY, Taipei (TW)

(21) Appl. No.: 12/576,248

(22) Filed: Oct. 9, 2009

(30) Foreign Application Priority Data
Aug. 6, 2009 (TW) 98126593

(51) Int. Cl. H04W 72/04

(52) U.S. Cl. 370/329

(57) ABSTRACT

A method for assigning wireless network transmission resource includes the following steps: at least one contention area is broadcasted. A join message is uplinked to a base station (BS) by at least one client utilizing the contention area. Determine if the join message received by the BS has been interfered with. If the join message received by the BS has not been interfered with, the contention area is assigned to the client. The client utilizes the contention area to upload data.

### RELATED APPLICATIONS

This application claims priority to Taiwan Application Serial Number 98126593, filed Aug. 6, 2009, which is herein incorporated by reference.

### BACKGROUND

1. Field of Invention

The present invention relates to a method for assigning resource and application thereof. More particularly, the present invention relates to an assigning wireless network transmission resource and application thereof.

2. Description of Related Art

As the cost of optical fibers or copper wires increases, broadband wireless backhaul technologies have become a key element of cost-effective broadband wireless networks. Wireless backhaul is the use of wireless communications systems to get data from an end user to a node in a major network such as the Internet. Wherein, multi-hop, or ad hoc, network is often utilized in the wireless backhaul network for routing.

In the multi-hop network, if neighboring clients utilize the same wireless network transmission resource (such as time domain, frequency domain or spatial domain) to upload data, the uploaded data would interfere with one another. Therefore, clients in the multi-hop network are assigned different wireless network transmission resources to upload to prevent interference, which causes low utilization ratio of the wireless network transmission resource.

To increase the utilization ratio of the wireless network transmission resource without interference, same wireless network transmission resource is assigned to several clients, which don't interfere with each other during uploading data. In the prior art, signal strengths of the clients are measured for calculating interferences of the clients, which needs additional measuring hardware and costs additional system resource for calculating interferences according to the signal strengths.

### SUMMARY

According to one embodiment of the invention, a method for assigning wireless network transmission resource includes the following steps: at least one contention area is broadcasted. A join message is uplinked to a base station (BS) by at least one client utilizing the contention area. Determine if the join message received by the BS has been interfered with. If the join message received by the BS has not been interfered with, the contention area is assigned to the client. The client utilizes the contention area to upload data.

According to another embodiment of the invention, a wireless network system includes at least one relay station (RS) and a BS. The RS serves at least one client. The BS includes a wireless transmission element and a processing element. The processing element is electrically connected with the wireless transmission element. The processing element includes a broadcasting module, a determining module and an assigning module. The broadcasting module broadcasts at least one contention area through the wireless transmission element. Wherein, if the client receives the contention area, the client utilizes the contention area to uplink a join message to the RS. The RS forwards the join message to the BS. If the join message is received through the wireless transmission element of the BS, the determining module determines if the received join message has been interfered with. If the received join message has not been interfered with, the assigning module assigns the contention area to the client, such that the client utilizes the contention area to upload data.

According to another embodiment of the invention, a storage medium stores several instructions to execute a method for assigning wireless network transmission resource. Wherein, the method for assigning wireless network transmission resource includes the following steps: at least one contention area is broadcasted. A join message is uplinked to a BS by at least one client utilizing the contention area. Determine if the join message received by the BS has been interfered with. If the join message received by the BS has not been interfered with, the contention area is assigned to the client. The client utilizes the contention area to upload data.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of a wireless network system according to an embodiment of this invention; and

FIG. 2 is a flow diagram of a method for assigning wireless network transmission resource 600 according to another embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

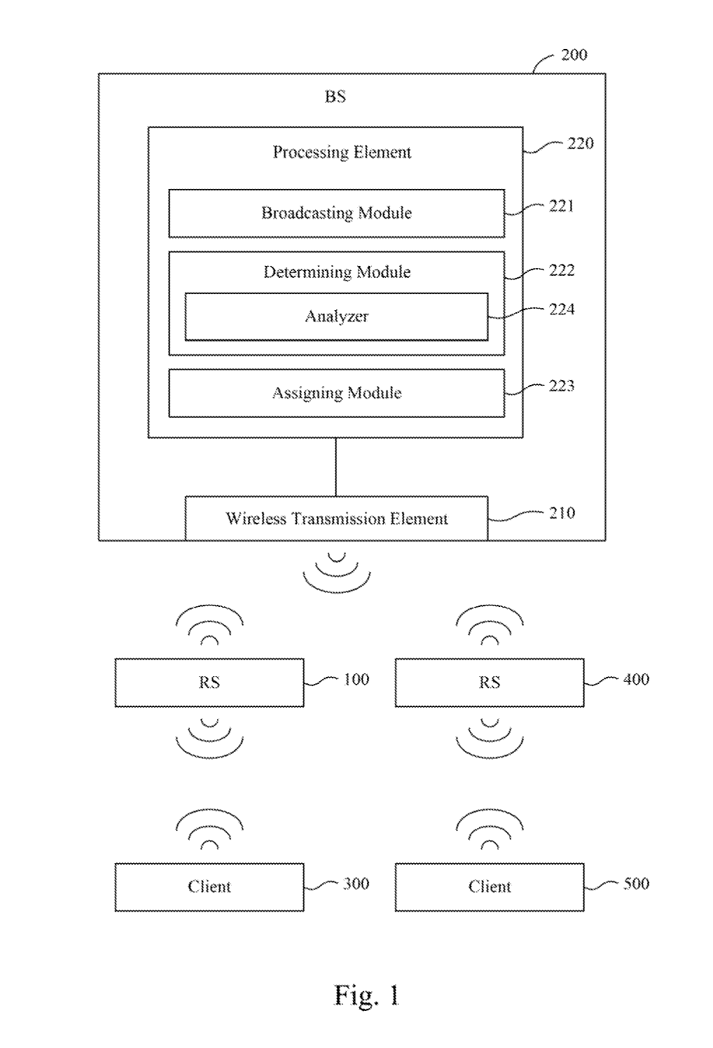

FIG. 1 is a block diagram of a wireless network system according to an embodiment of this invention. In the wireless network system, a client utilizes a contention area broadcasted by a BS to uplink a join message to the BS. If the BS determines that the join message received from the client has not been interfered with, the contention area is assigned to the client to upload data.

The wireless network system includes a RS 100 and a BS 200. The RS 100 serves a client 300. Wherein, the RS 100, the BS 200 and the client 300 communicate with each other utilizing IEEE 802.16j or any other wireless network protocol supporting multi-hop (or Ad-hoc). In addition, in other embodiments, the RS may serve more than one client.

The BS 200 includes a wireless transmission element 210 and a processing element 220. The wireless transmission element 210 is electrically connected with the processing element 220, and is used for transmitting data utilizing wirelessly. The processing element 220 includes a broadcasting module 221, a determining module 222 and an assigning module 223. The broadcasting module 221 broadcasts at least one contention area through the wireless transmission element 210. Wherein, the contention area may include at least one available time domain, at least one available frequency domain, at least one available spatial domain, or any other available wireless network transmission resource.

When the client 300 receives the contention area, the client 300 utilizes the contention area to uplink a join message to the RS 100, and the RS 100 forwards the join message received from the client 300 to the BS 200. Wherein, the client 300 may receive the contention area directly from the BS 200 or the RS 100, which forwards the contention area broadcasted by the BS 200.

When the join message is received from the client 300 through the wireless transmission element 210 of the BS 200, the determining module 222 determines if the join message from the client 300 has been interfered with. Wherein, since information in the interfered join message may not be recognized, the client 300 may embed identification information in the join message for the mentioned determination of the determining module 222. In addition, the determining module 222 may include an analyzer 224 to analyze the join message from the client 300. Wherein, if the identification information of the client 300 can be analyzed from the join message from the client 300, the determining module 222 determines that the join message from the client 300 has not been interfered.

The client 300 utilizes the contention area to uplink the join message without interference, which implies that the client 300 can utilize the contention area to upload data without interference. Therefore, if the join message from the client 300 has not been interfered with, the assigning module 223 assigns the contention area to the client 300. Then, the client 300 can utilize the contention area to upload data.

In addition, the wireless network system may include another RS 400 serving another client 500. Wherein, if the client 500 receives the contention area, the client 500 utilizes the contention area to uplink a join message to RS 400, and the RS 400 forwards the received join message to BS 200. Wherein, the client 500 may receive the contention area directly from the BS 200. In addition, the client 500 may receive the contention area from the RS 400, who forwards the contention area broadcasted by the BS 200.

If the determine module 222 determines that the join message from the client 500 has not been interfered with, the assigning module 223 assigns the contention area to the client 500. Then, the client 300 and 500 can utilize the same contention area to upload data. Therefore, contention area can be assigned to several clients without interference, which raises the utilization rate of the contention area.

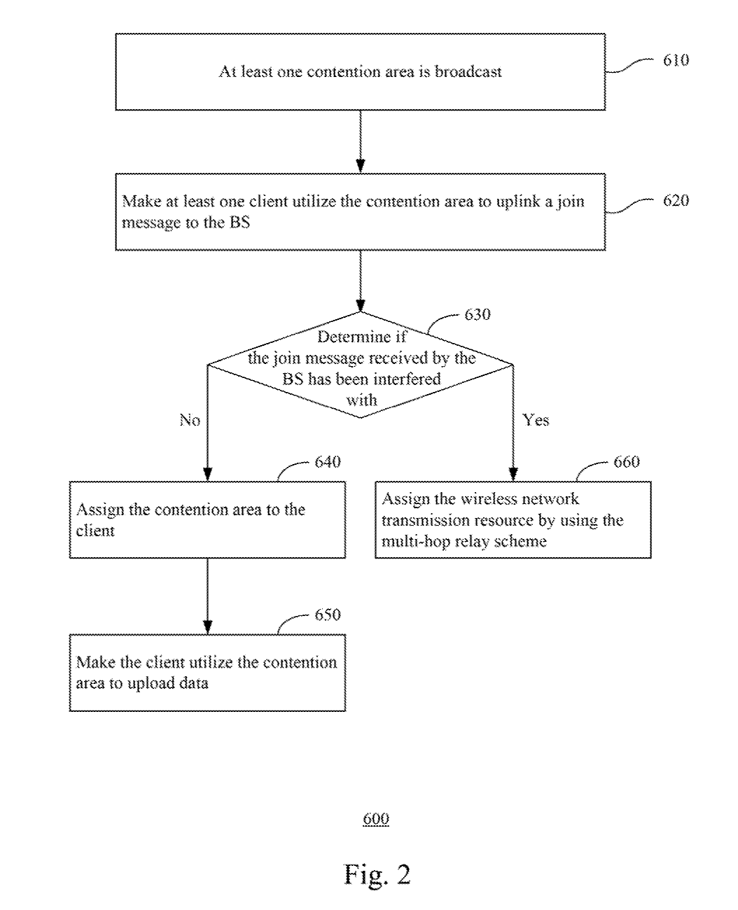

FIG. 2 is a flow diagram of a method for assigning wireless network transmission resource 600 according to another embodiment of this invention. In the method for assigning wireless network transmission resource 600, a client utilizes a contention area broadcasted by a BS to uplink a join message to the BS. If the join message received by the BS has not been interfered with, the contention area is assigned to the client for upload. The method for assigning wireless network transmission resource 600 may take the form of a computer program product on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives.

The method for assigning wireless network transmission resource 600 includes the following steps:

In the step 610, at least one contention area is broadcast. Wherein the contention area can be broadcasted by a BS, or forwarded by at least one RS. The contention area may include at least one available time domain, at least one available frequency domain, at least one available spatial domain, or any other available wireless network transmission resource.

In the step 620, make at least one client utilize the contention area to uplink a join message to the BS. Wherein the client utilizes multi-hop networking to uplink the join message, which means that the client utilizes the contention area to uplink the join message to a RS and the RS forwards the join message to the BS. In addition, if the number of the at least one contention area is more than one, one of the contention areas may be selected by the client and the client may utilize the selected contention area to uplink the join message to the BS.

For example, if the contention area includes several available frequency domains, a common time domain may be broadcasted and the client may select one of the available frequency domains. Then, the client may utilize the selected available frequency domain to uplink the join message to the BS (step 620) during the common time domain.

In another embodiment, if the contention area includes several available time domains, a common frequency domain may be broadcasted and the client may select one of the available time domains. Then, the client may utilize the common frequency domain to uplink the join message to the BS (step 620) during the selected available time domain.

In the step 630, determine if the join message received by the BS has been interfered with. Wherein, since information in the interfered join message may not be recognized, the client may embed identification information in the join message, and the join message received by the BS may be analyzed for the determination of the step 630. If the identification information of the client can be analyzed from the join message received by the BS, the join message received by the BS is determined none-interfered.

If the join message from the client has not been interfered with, assign the contention area to the client (step 640), and make the client utilize the contention area to upload data (step 650). Wherein, the client utilizes the multi-hop networking to upload data (step 650). In addition, the client can utilize the contention area to uplink the join message (step 620) without interference, which implies that the client can utilize the contention area to upload data (step 650) without interference. Therefore, if there are several clients, the contention area may be assigned to more than one client without interference, which raises the utilization rate of the contention area.

If the join message from the client is determined interfered, assign the wireless network transmission resource by using the multi-hop relay scheme (step 660). Therefore, the wireless network transmission resource can still be assigned to the client when the join message from the client has been interfered with.

Above all, by assigning a same wireless network transmission resource to several different clients for upload, the utilization rate of the wireless network transmission resource can be raised. In addition, the assignment of the wireless network transmission resource can be achieved without additional hardware for measuring signal-strength. Therefore, embodiments in this invention are compatible with present wireless network systems.

Although the present invention has been described in considerable detail with reference to certain embodiments thereof, other embodiments are possible. Therefore, their spirit and scope of the appended claims should no be limited to the description of the embodiments container herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for assigning wireless network transmission resource, comprising:
broadcasting at least one contention area;
making at least one client utilize the contention area to uplink a join message to a base station (BS);
determining if the join message received by the BS has been interfered with;
if the received join message has not been interfered with, assigning the contention area to the client; and
making the client utilize the contention area to upload data.

2. The method for assigning wireless network transmission resource of claim 1, wherein if the number of the at least one client is more than one and the join messages received from the clients have not been interfered, assign the contention area to the clients, which uplink the non-interfered join messages, such that the clients, which uplink the non-interfered join messages, utilize the contention area to upload data.

3. The method for assigning wireless network transmission resource of claim 1, wherein if the number of the at least one contention area is more than one, the step of making the client utilizing the contention areas uplink the join message to the BS comprises:
making the client select one of the contention areas; and
making the client utilize the selected contention area to uplink the join message to the BS.

4. The method for assigning wireless network transmission resource of claim 1, wherein the contention area comprises at least one available time domain, at least one available frequency domain or at least one available spatial domain.

5. The method for assigning wireless network transmission resource of claim 1, wherein if the contention area comprises a plurality of available frequency domains, the step of making the client utilize the contention area to uplink the join message to the BS comprises:
broadcasting a common time domain;
making the client select one of the available frequency domains; and
making the client utilize the selected available frequency domain to uplink the join message to the BS during the common time domain.

6. The method for assigning wireless network transmission resource of claim 1, wherein if the contention area comprises a plurality of available time domains, the step of making the client utilize the contention area to uplink the join message to the BS comprises:
broadcasting a common frequency domain;
making the client select one of the available time domains; and
making the client utilize the common frequency domain to uplink the join message to the BS during the selected available time domain.

7. The method for assigning wireless network transmission resource of claim 1 wherein the step of making the client utilize the contention area to uplink the join message to the BS comprises:
making the client utilizing the contention area to uplink the join message to a relay station (RS); and
making the RS forward the received join message to the BS.

8. The method for assigning wireless network transmission resource of claim 1, further comprising:
making the client embed identification information of the client in the join message for uplink; and
analyze the join message received by the BS, wherein if the identification information of the client can be analyzed from the join message received by the BS, the join message received by the BS is determined none-interfered.

9. The method for assigning wireless network transmission resource of claim 1, wherein multi-hop networking is utilized for making the client utilize the contention area to uplink the join message to the BS and making the client utilize the contention area to upload data.

10. A wireless network system, comprising:
at least one RS to serve at least one client; and
a BS, comprising:
a wireless transmission element; and
a processing element, electrically connected with the wireless transmission element, comprising:
a broadcasting module to broadcast at least one contention area through the wireless transmission element, wherein the client utilizes the contention area to uplink a join message to the RS when the contention area is received by the client, and the RS forwards the join message to the BS;
a determining module to determine if the received join message has been interfered with when the join message is received through the wireless transmission element; and
an assigning module to assign the contention area to the client if the received join message has not been interfered with, such that the client utilizes the contention area to upload data.

11. The wireless network system of claim 10, wherein the client embeds identification information of the client in the join message for uplink, and the determining module of the BS comprises:
an analyzer to analyze the received join message, wherein if the identification information of the client can be analyzed from the received join message, the received join message is determined none-interfered.

12. The wireless network system of claim 10, wherein the contention area comprises at least one available time domain, at least one available frequency domain or at least one available spatial domain.

13. A storage medium to store a plurality of instructions to execute a method for assigning wireless network transmission resource, wherein the method for assigning wireless network transmission resource comprises:
broadcasting at least one contention area;
making at least one client utilize the contention area to uplink a join message to a BS;
determining if the join message received by the BS has been interfered with;
if the received join message has not been interfered with, assigning the contention area to the client; and
making the client utilize the contention area to upload data.

14. The storage medium of claim 13, wherein if the number of the at least one client is more than one and the join messages received from the clients have not been interfered, assign the contention area to the clients, which uplink the non-interfered join messages, such that the clients, which uplink the non-interfered join messages, utilize the contention area to upload data.

15. The storage medium of claim 13, wherein if the number of the at least one contention area is more than one, the step of making the client utilizing the contention areas uplink the join message to the BS comprises:
making the client select one of the contention areas; and
making the client utilize the selected contention area to uplink the join message to the BS.

16. The storage medium of claim 13, wherein the contention area comprises at least one available time domain, at least one available frequency domain or at least one available spatial domain.

17. The storage medium of claim 13, wherein if the contention area comprises a plurality of available frequency domains, the step of making the client utilize the contention area to uplink the join message to the BS comprises:
broadcasting a common time domain;
making the client select one of the available frequency domains; and
making the client utilize the selected available frequency domain to uplink the join message to the BS during the common time domain.

18. The storage medium of claim 13, wherein if the contention area comprises a plurality of available time domains, the step of making the client utilize the contention area to uplink the join message to the BS comprises:
broadcasting a common frequency domain;
making the client select one of the available time domains; and
making the client utilize the common frequency domain to uplink the join message to the BS during the selected available time domain.

19. The storage medium of claim 13 wherein the step of making the client utilize the contention area to uplink the join message to the BS comprises:
making the client utilize the contention area to uplink the join message to a RS; and
making the RS forward the received join message to the BS.

20. The storage medium of claim 13, wherein the method for assigning wireless network transmission resource further comprises:
making the client embed identification information of the client in the join message for uplink; and
analyze the join message received by the BS, wherein if the identification information of the client can be analyzed from the join message received by the BS, the join message received by the BS is determined none-interfered.

21. The storage medium of claim 13, wherein multi-hop networking is utilized for making the client utilize the contention area to uplink the join message to the BS and making the client utilize the contention area to upload data.
